(19) United States
(12) Patent Application Publication
(10) Pub. No.: US 2025/0197073 A1
(43) Pub. Date: Jun. 19, 2025

(54) TABLET CRUSHER BOTTLE

(71) Applicant: PepsiCo, Inc., Purchase, NY (US)

(72) Inventors: Marco CIMATTI, Sleepy Hollow, NY (US); Michel ALVAREZ, Miami, FL (US)

(21) Appl. No.: 18/544,893

(22) Filed: Dec. 19, 2023

(51) Int. Cl. B65D 51/24; B02C 2/04

(52) U.S. Cl. CPC B65D 51/24; B02C 2/04

(57) ABSTRACT

A bottle includes a vessel, a grate, and a lid. The vessel includes an opening. The grate is positioned at the opening. The lid is lid configured to seal the opening. The lid comprises a shaft and a first threaded portion. The bottle also includes a second threaded portion. The first threaded portion and second threaded portion are configured such that threadedly advancing the first threaded portion into the second threaded portion moves the shaft toward the grate.

### BACKGROUND

Beverage flavoring products in a variety of formats have become popular. One such format is a dissolvable tablet, wherein flavoring ingredients are provided in the form of a solid, pre-portioned article intended for placement directly in a liquid to be flavored. Compared to some other pre-portioned formats, such as sachets of powder, dissolvable tablets require relatively little packaging, since tablets can be distributed in any quantity within a single appropriately sized container, and can therefore be an environmentally friendly option for distribution of pre-portioned flavoring products. Tablets can also be easier to handle and less likely to create mess and wasted product than some other formats, such as some powder and liquid flavoring products.

For a variety of reasons, tablets are frequently produced in shapes with relatively little surface area compared to their volume. Accordingly, tablets can take several minutes to dissolve in a beverage. Some users may find the delay between adding a tablet to a liquid and full dissolution of the tablet undesirable, since users may wish to drink the flavored beverage quickly during circumstances such as during or after athletic or other strenuous physical activity, in circumstances of elevated temperature, or when the liquid to be flavored is hot or cold and approaches room temperature while the user waits.

### BRIEF SUMMARY

A need exists for a convenient way to expedite the dissolution of tablets or other items in a stored liquid. Accordingly, aspects of the present disclosure are directed to a bottle provided with a mechanism for crushing items. In some such aspects, the mechanism is capable of crushing the items in a cavity that is in fluid communication with a volume capable of storing liquid. In some such further aspects, the cavity and the volume can be sealed such that the bottle can be agitated to cause liquid and crushed particles to pass between the cavity and the volume. In further aspects, the bottle comprises a vessel for storing liquid, a grate, and a lid, and the lid comprises a shaft configured to crush items against the grate while the lid seals an opening of the vessel. In some such further aspects, the grate is positioned across a portion of the opening so that a cavity defined between the grate and the lid is in fluid communication with an interior space of the vessel. Such solutions can contribute to a positive user experience and be environmentally friendly by encouraging users to select beverage flavoring formats that require relatively little packaging.

In some aspects of the present disclosure, a bottle may comprise a vessel, a grate, a lid, and a second threaded portion. The vessel may comprise an opening. The grate may be positioned at the opening. The lid may be configured to seal the opening. The lid may comprise a shaft and a first threaded portion. The first threaded portion and the second threaded portion may be configured such that threadedly advancing the first threaded portion into the second threaded portion moves the shaft toward the grate.

In some examples according to any of the foregoing, the vessel may comprise the second threaded portion.

In some examples according to any of the foregoing, the lid may seal the opening when the first threaded portion is advanced into the second threaded portion such that the lid reaches a first position relative to the vessel.

In some examples according to any of the foregoing, the first threaded portion may be advanced into the second threaded portion to move the lid past the first position to a second position. The shaft may nest against the grate when the lid is in the second position.

In some examples according to any of the foregoing, the grate may extend across the opening.

In some examples according to any of the foregoing, the vessel may comprise the second threaded portion and an open end. The opening may be defined in the open end. The second threaded portion may be located between the grate and the open end.

In some examples according to any of the foregoing, the vessel may comprise a shoulder on an opposite side of the grate from the opening.

In some examples according to any of the foregoing, a portion of the grate may have a first cone shape and an end of the shaft may have a second cone shape. The second cone shape may be complementary to the first cone shape.

In some examples according to any of the foregoing, the lid may comprise the second threaded portion. The shaft may comprise the first threaded portion.

In some examples according to any of the foregoing, the lid may further comprise a ring that encircles the shaft and comprises the second threaded portion.

In some examples according to any of the foregoing, the vessel may comprise a third threaded portion and the lid comprises a fourth threaded portion. The lid may be configured to seal the opening when the fourth threaded portion is threadedly engaged with the third threaded portion.

In some aspects of the present disclosure, a vessel may comprise an opening and an interior space. The opening may be a passage through which substances from outside of the vessel can reach the interior space. The vessel may also comprise a grate. The vessel may also comprise a lid configured to cover the grate. The lid may comprise a shaft. A distance of the shaft from the grate may be adjustable while the lid is connected to the vessel and covers the opening. The grate may be positioned so that substances on an opposite side of the grate from the shaft can reach the interior space.

In some examples according to any of the foregoing, the shaft may be movable to nest against the grate while the lid is connected to the vessel and covers the opening.

In some examples according to any of the foregoing, a crushing area of the grate may have a first cone shape. An end of the shaft may have a second cone shape. The shaft may be movable to a position wherein the end of the shaft nests against the crushing area while the lid is connected to the vessel and covers the opening.

In some aspects of the present disclosure, a method of using the bottle according to some of the foregoing examples may comprise placing liquid in the vessel. The method may also comprise placing an item between the shaft and the grate. The method may also comprise crushing the item by advancing the shaft toward the grate while the item is between the shaft and the grate.

In some examples according to any of the foregoing, placing the item between the shaft and the grate may comprise placing the item on the grate then connecting the shaft to the vessel.

In some examples according to any of the foregoing, the method may comprise, after crushing the item, withdrawing the shaft from the grate to a position wherein a cavity exists between the grate and the shaft while the lid seals the opening. The method may also comprise, after crushing the item, agitating the liquid into the cavity by moving the bottle.

In some examples according to any of the foregoing, the method may comprise, after withdrawing the shaft, orienting the bottle so that the opening points downward. The method may also comprise agitating liquid out of the cavity by moving the bottle.

In some examples according to any of the foregoing, the advancing the shaft toward the grate may comprise threadedly advancing a first threaded portion of the bottle along a second threaded portion of the bottle.

In some examples according to any of the foregoing, the item may be a consumable tablet.

Additional embodiments and advantages of the disclosure will be set forth, in part, in the description that follows, and will flow from the description, or can be learned by practice of the disclosure.

It is to be understood that both the foregoing summary and the following detailed description are exemplary and explanatory only, and do not restrict the scope of the claims.

### BRIEF DESCRIPTION OF THE DRAWINGS

FIG. 1A is a perspective view of a bottle according to some aspects of the present disclosure.

FIG. 1B is a perspective view of the bottle of FIG. 1A with tablets placed therein.

FIG. 1C is a cross-sectional elevation view of the bottle of FIG. 1A in a first state.

FIG. 1D is the cross-sectional view of FIG. 1C with the bottle of FIG. 1A in a second state.

FIG. 1E is the cross-sectional view of FIG. 1C with the bottle of FIG. 1A in a third state.

FIG. 2 is a flowchart illustrating a method of using the bottle of FIG. 1A.

FIG. 3A is a cross-sectional view of a bottle according to some aspects of the present disclosure in a first state.

FIG. 3B is the cross-sectional view of the bottle of FIG. 3A in a second state.

### DETAILED DESCRIPTION

The present invention will now be described in detail with reference to embodiments thereof as illustrated in the accompanying drawings. References to “one embodiment,” “an embodiment,” “an example embodiment,” “some embodiments,” etc., indicate that the embodiment described may include a particular feature, structure, or characteristic, but every embodiment described may not necessarily include that particular feature, structure, or characteristic. Similarly, other embodiments may include additional features, structures, or characteristics. Moreover, such phrases are not necessarily referring to the same embodiment. When a particular feature, structure, or characteristic is described in connection with the embodiment, it is submitted that it is within the knowledge of one skilled in the art to effect such feature, structure, or characteristic in connection with other embodiments whether or not explicitly described.

The terms “invention,” “present invention,” “disclosure,” or “present disclosure” as used herein are non-limiting terms and are not intended to refer to any single embodiment of the particular invention but encompasses all possible embodiments as described in the application.

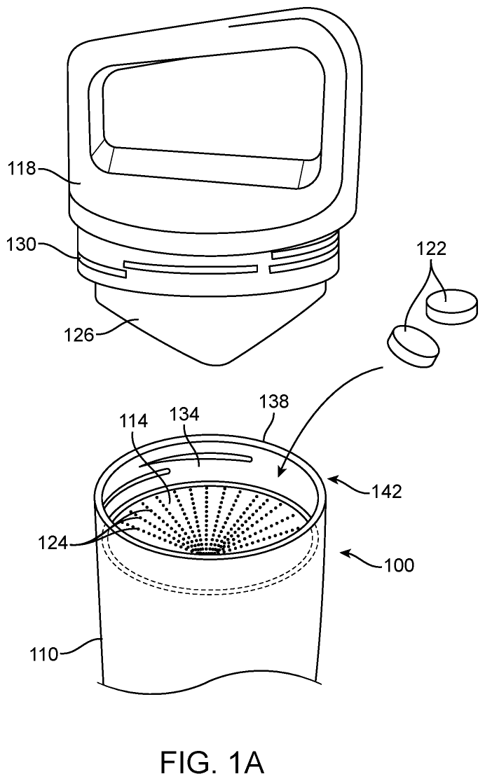

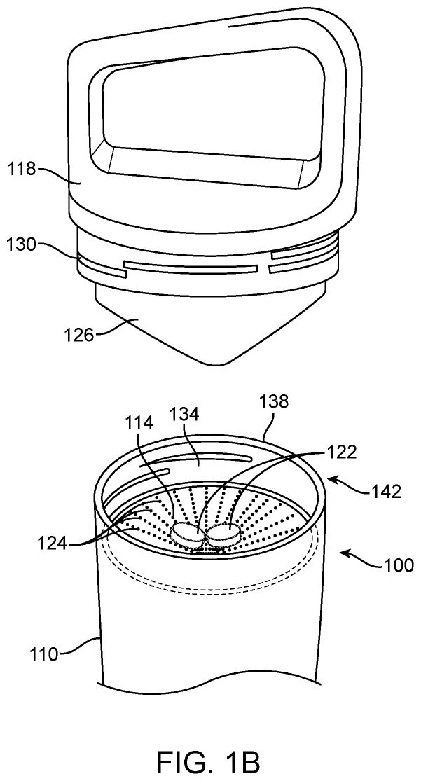

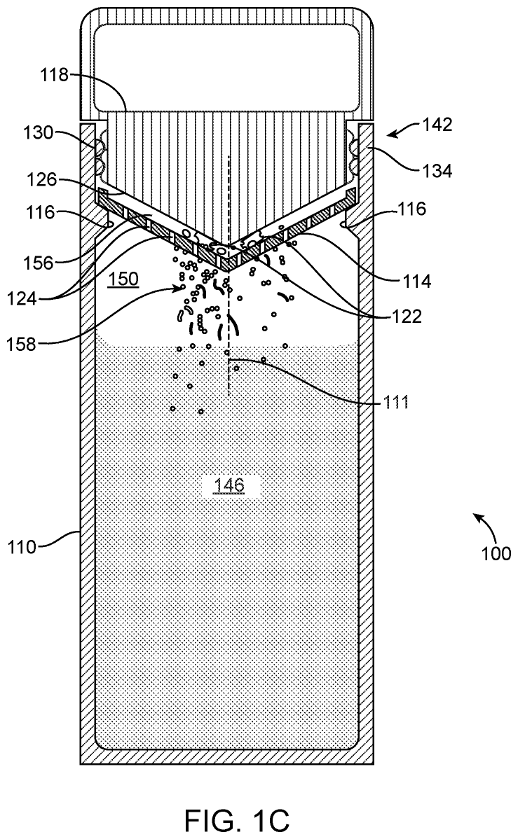

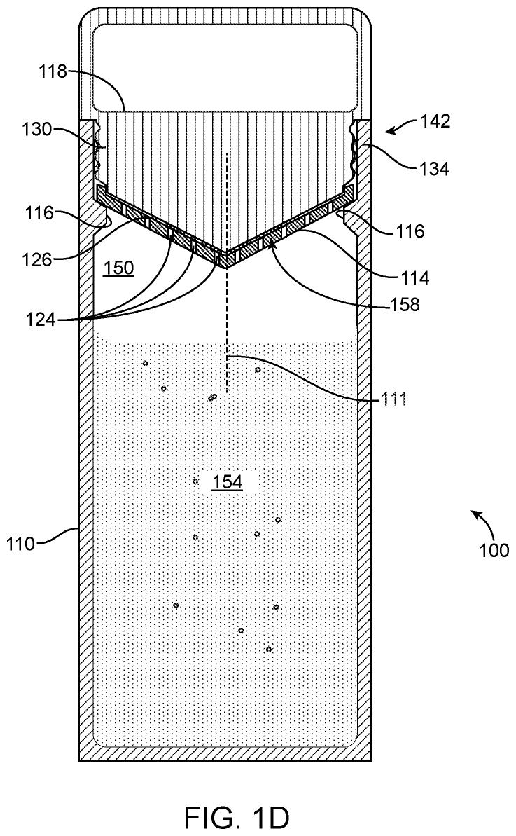

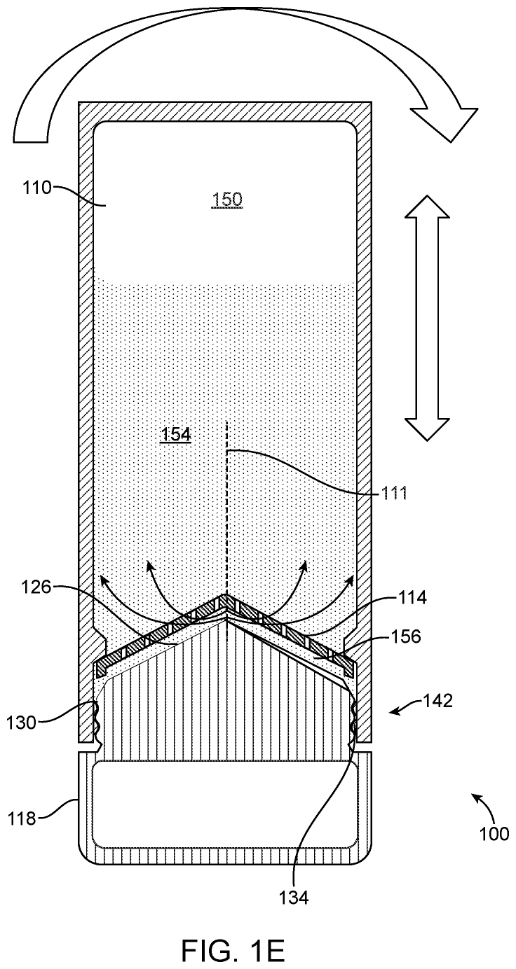

FIG. 1A shows a bottle 100 comprising a vessel 110, a grate 114, and a lid 118. Lid 118 is configured to crush items such as tablets 122 against grate 114. Grate 114 is an element with openings 124 defined therethrough, such as mesh, perforated sheet, or lattice, that allows fluids and small particles to pass through grate 114 to reach an interior space of vessel 110. Tablets 122, such as flavoring tablets, are used for illustrative purposes herein, but bottle 100 can be used to crush other items, such as, for example, pills, nutritional supplements, fruit, vegetables, or any other item that may be advantageous to crush within a bottle.

Vessel 110 comprises an open end 142 wherein an opening 138 is defined. Vessel 110 further comprises an interior space 150. Opening 138 is a passage through which substances from outside vessel 110 may enter interior space 150 and substances from interior space 150 may exit vessel 110. Grate 114 extends across at least a portion of opening 138. Grate 114 is positioned so that substances on an opposite side of grate 114 from shaft 126 can reach interior space 150. Specifically, substances on an opposite side of grate 114 from shaft 126 can reach interior space 150 without passing through grate 114. Shaft 126 can therefore be used to force substances through grate 114 into interior space 150. In some examples, grate 114 can further be positioned so that substances on an opposite side of grate 114 from shaft 126 will tend to fall into interior space. In the illustrated example, when bottle 100 is oriented in a typical upright position, grate 114 is positioned above interior space 150 and shaft 126 is positioned above grate 114, meaning substances on an opposite side of grate 114 from shaft 126 will tend to fall toward a bottom end of interior space 150. However, bottle 100 may be oriented in different positions than those illustrated, and in other examples grate 114 and shaft 126 may be positioned elsewhere within bottle 100.

In the illustrated example, grate 114 extends across the entire opening 138, though in other examples, grate 114 can extend across less than the entire opening 138. As shown in FIGS. 1C and 1D, vessel 110 according to some examples can optionally also comprise one or more protrusions 116 that extend radially inward into interior space 150 of vessel 110 to support grate 114. The one or more protrusions 116 can be provided, for example, in a single annular ledge extending entirely around interior space 150 or as a plurality of distinct posts or ledges. The one or more protrusions 116 can create an effective inner diameter less than an exterior diameter of grate 114 and thereby resist grate 114 being pushed axially away from opening 138.

Lid 118 comprises a shaft 126 configured to crush items against grate 114. Shaft 126 and grate 114 can cooperate to act as a mill, wherein shaft 126 acts as the runner and grate 114 acts as the bed. As shown in FIG. 1A, an end of shaft 126 of the illustrated example has a convex cone shape. Grate 114 of the illustrated example has a similar cone shape that is concave on the side facing lid 118. Grate 114 and shaft 126 of the illustrated example are therefore complementary in shape such that shaft 126 can nest against grate 114, as described further below and illustrated in FIG. 1D. In the context of complementary convex and concave shapes, such as the complementary shapes of the end of shaft 126 and grate 114 in the illustrated example, one element nesting within another can include positioning of the convexity of one of the complementarily shaped elements within the concavity of the other of the complementarily shaped elements. In other examples, such as wherein grate 114 and the end of shaft 126 are both perpendicular to axis 111 and flat, or at least substantially flat, the end of shaft 126 can nest against grate 114 by approaching grate such that a space less than the thickness of a typical swallowable pill remains between the end of shaft 126 and grate 114. By nesting, grate 114 and shaft 126 allow lid 118 to be positioned to leave little or no space between shaft 126 and grate 114, thereby contributing to effective crushing of tablets 122 between grate 114 and shaft 126. The cone shapes of grate 114 and shaft 126 further allow for shaft 126 to rotate relative to grate 114 when grate 114 and shaft 126 are nested, meaning lid 118 can be threadedly advanced into or withdrawn from positions wherein little or no space is left between grate 114 and shaft 126. Compared to some other shapes, the complementary cone shapes of grate 114 and shaft 126 of the illustrated example can also provide mechanical advantage for crushing items between grate 114 and shaft 126. However, grate 114 and shaft 126 can have other shapes in other examples.

In the illustrated example, lid 118 comprises a lid threaded portion 130 while vessel 110 comprises a complementary vessel threaded portion 134. Shaft 126 can therefore be advanced toward or withdrawn from grate 114 by turning lid 118 when lid threaded portion 130 is engaged with vessel threaded portion 134. Lid 118 can be advanced along a thread axis 111 on which vessel threaded portion 134 is centered and about which lid 118 rotates when lid threaded portion 130 is threadedly advanced into vessel threaded portion 134. Vessel threaded portion 134 can be positioned between grate 114 and opening 138, or between grate 114 and open end 142, as shown. Further, lid threaded portion 130 can encircle shaft 126 as shown. Threaded portions 130, 134 of the illustrated example can therefore provide a mechanical advantage for crushing tablets 122 between grate 114 and shaft 126. Threaded portions 130, 134 of the illustrated example can further be configured create a seal between vessel 110 and lid 118 such that liquid cannot escape vessel 110 through opening 138 when threaded portions 130, 134 are threadedly engaged and lid threaded portion 130 is threadedly advanced into vessel threaded portion 134 to at least a certain degree. Thus, threaded portions 130, 134 according to some examples can be of a type that creates a fluid seal when threadedly engaged. However, lid 118 can be connectable to vessel 110 by other mechanisms in other examples.

Bottle 100 of the illustrated example thus comprises a vessel 110 comprising an opening 134 and a grate 114 positioned at opening 134. Bottle 100 further comprises a lid 118 configured to seal opening 134, and lid 118 comprises a shaft 126. Bottle 100 further comprises a first threaded portion 130 and a second threaded portion 134, wherein first threaded portion 130 and second threaded portion 134 are configured such that threadedly advancing first threaded portion 130 into second threaded portion 134 moves shaft 126 toward grate 114. In the illustrated example, lid 118 comprises only first threaded portion 130, whereas lid 118 may additionally or alternatively comprise the second threaded portion in other examples.

In the illustrated example, vessel 110 comprises second threaded portion 134. Lid 118 seals opening 138 when first threaded portion 130 is advanced into second threaded portion 134 such that lid 118 reaches a first position relative to vessel 110. First threaded portion 130 can be advanced into second threaded portion 134 to move lid 118 past the first position to a second position, wherein shaft 126 can nest with grate 114 when lid 118 is in the second position. In some examples, including the illustrated example, shaft 126 can contact grate 114 when lid 118 is in the second position.

Further according to the illustrated example, bottle 100 comprises a vessel 110. Vessel 110 comprises an opening 138. Bottle 100 further comprises a grate 114 and a lid 118 configured to cover grate 114. Lid 118 comprises a shaft 126. A position of shaft 126 relative to grate 114 is adjustable while lid 118 is connected to vessel 110 and covers opening 138. Shaft 126 is movable into a position wherein shaft 126 with grate 114 while lid 118 is connected to vessel 110 and covers opening 138. In some examples, including the illustrated example, shaft 126 is movable into contact with grate 114 while lid 118 is connected to vessel 110 and covers opening 138. A crushing area of grate 114 has a first cone shape, an end of shaft 126 has a second cone shape. Shaft 126 is movable to a position wherein the end of shaft 126 nests within the crushing area while lid 118 is connected to vessel 110 and covers opening 138.

An example of a process for using bottle 100 is shown in FIGS. 1A-1E in sequence. Tablets 122 are used as an example of a type of item that can be crushed and mixed in the process of FIGS. 1A-1E, but the same process can be used with any other item crushable by bottle 100 as noted above.

As shown in FIG. 1A, tablets 122 can be placed in vessel 110 upon grate 114. As further shown in FIG. 1B, tablets 122 may naturally travel toward a point of the concave cone shape of grate 114 when placed thereon.

As shown in FIG. 1C, lid 118 can be engaged with vessel 110 to define a cavity 156 between grate 114 and shaft 126. In some examples, lid 118 can be configured to fluidly seal cavity 156 such that fluid and particles within cavity 156 cannot escape vessel 110 past lid 118. In the illustrated example, lid 118 engages vessel 110 and fluidly seals cavity 156 by a threaded engagement between lid threaded portion 130 and vessel threaded portion 134. Vessel 110 of the illustrated example comprises only one opening, namely opening 138 shown in FIGS. 1A and 1B, meaning sealing opening 138 with lid 118 is sufficient to prevent liquid and particles from escaping vessel 110 of the illustrated example, but vessel 110 according to other examples can include additional sealable openings (e.g., a drinking spout). Lid 118 can be connected to vessel 110 after tablets 122 are placed on grate 114 to trap tablets 122 in a cavity 156 defined between grate 114 and shaft 126. Connecting lid 118 to vessel 110 also connects shaft 126 to vessel 110. Thus, shaft 126 may be connected to vessel 110 after tablets 122 have been placed on grate 114.

As also shown in FIG. 1C, an interior space 150 of vessel 110 is at least partially filled with a liquid 146, such as, for example, water. Liquid 146 can be added to vessel 110 before, during, or after placement of tablets 122. Liquid 146 can be added to vessel 110 by pouring liquid 146 through opening 138. Liquid 146 can further be added to vessel 110 by pouring liquid 146 through grate 114 such that liquid 146 passes through grate 114 to interior space 150. In some examples, grate 114 can be removable from vessel 110. In some such examples, grate 114 can be removed before liquid 146 is added to vessel 110, and liquid 146 can be poured through opening 138 into interior space 150 without passing through grate 114.

Advancing shaft 126 toward grate 114 can compress tablets 122 between shaft 126 and grate 114. Tablets 122 can therefore be crushed by advancing shaft 126 toward grate 114 while tablets 122 are disposed within cavity 156. As further shown in FIG. 1C, crushing tablets 122 between shaft 126 and grate 114 causes tablets 122 to produce particles 158. Particles 158 can pass through grate 114 to reach liquid 146.

Turning to FIG. 1D, shaft 126 of the illustrated example can be advanced to nest with grate 114 to crush tablets 122. In some examples, the nesting position of shaft 126 with grate can be in contact with grate 114 or nearly in contact with grate 114. The combination of particles 158 with liquid 146 results in mixture 154. In some examples, mixture 154 can itself be a liquid (e.g., with particles dissolved or suspended therein). Some particles 158 may remain trapped between grate 114 and shaft 126 after tablets 122 are crushed.

Multiple actions shown in FIG. 1E are available to complete the collection of particles 158 into mixture 154. These actions may be taken in any order, combination, and number of repetitions. Lid 118 can be operated to withdraw shaft 126 from grate 114, thereby enlarging cavity 156 from the relatively small size or elimination of cavity 156 achieved when shaft 126 is advanced as far as desired toward grate 114 to crush tablets 122. Enlarging cavity 156 this way can facilitate liquid 146 or mixture 154 washing over particles 158 trapped between grate 114 and shaft 126. In some examples wherein tablets 122 are made of a substance dissolvable in liquid 146, such washing can be effective to incorporate the trapped particles 158 into mixture 154 and either eliminate the trapped particles 158 or reduce the size of the trapped particles 158 enough that the trapped particles 158 may pass through grate 114 to reach interior space 150.

Additionally, liquid 146 or mixture 154 can be agitated. In some examples, liquid 146 or mixture 154 can be agitated by moving vessel 110. For example, liquid 146 or mixture 154 can be agitated by any combination of translatory and rotational movements of vessel 110. As shown in FIG. 1E, liquid 146 or mixture 154 can be inverted and then shaken parallel to thread axis 111 after lid 118 has been operated to withdraw shaft 126 from grate 114 while remaining sufficiently engaged with vessel threaded portion 134 to seal opening 138. When applied to bottle 100 of the illustrated example, the foregoing sequence of actions can be successful in causing liquid 148 or mixture 154 to pass grate 114 to enter cavity 156 and wash over particles 158 trapped in cavity 156.

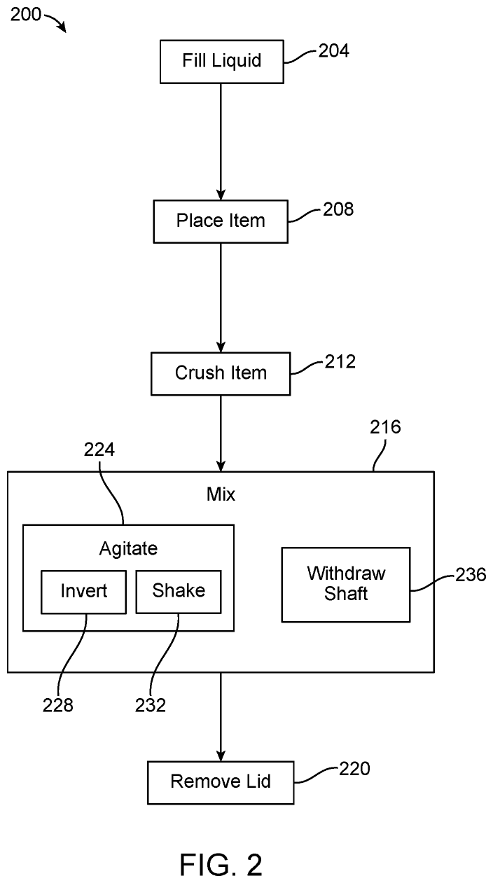

A process 200 for using a bottle with a grate and a shaft configured to crush items against the grate, such as bottle 100, is illustrated in FIG. 2. Process 200 according to the illustrated example begins with a filling step 204 in which liquid 146 is placed in an interior space 150 of vessel 110. As noted above, liquid 146 can be poured into interior space 150 through grate 114. In further examples, such as if grate 114 is configured to be removable from opening 138, liquid 146 can be poured past grate 114 to reach interior space 150 without passing through grate 114.

Filling step 204 is followed by placing step 208, wherein tablets 122 or other items are placed in cavity 156 defined between shaft 126 and grate 114. Placing step 208 can be conducted by, for example, placing tablets 122 upon grate 114 as shown in FIGS. 1A and 1B, then engaging lid 118 with vessel 110 to seal opening 138 as shown in FIG. 1C.

Lid 118 can be connected to vessel 110 after tablets 122 are placed on grate 114 to trap tablets 122 in a cavity 156 defined between grate 114 and shaft 126. Connecting lid 118 to vessel 110 also connects shaft 126 to vessel 110. Thus, within placing step 208, shaft 126 may be connected to vessel 110 after tablets 122 have been placed on grate 114.

Placing step 208 is followed by crushing step 212, wherein tablets 122 or other items are crushed between grate 114 and shaft 126 by operating lid 118 to advance shaft 126 toward grate 114 and thereby apply pressure to the tablets 122 or other items as shown in FIG. 1D. During crushing step 212, shaft 126 may be advanced to any position that crushes tablets 122 or other items to the desired degree.

Crushing step 212 is followed by mixing step 216. Mixing step 216 comprises mixing liquid 146 with the tablets 122 or other items, or particles 158 created during crushing step 212, to create mixture 154. Mixing step 216 can comprise in any order, combination, and number of repetitions, an agitating step 224 a withdrawal step 236, or both agitating step 224 and withdrawal step 236.

Agitating step 224 comprises agitating liquid 146 or mixture 154 to integrate tablets 122, other items, or particles 158 into mixture 154. Agitating step 224 can comprise, in any order, combination, and number of repetitions, inverting step 228, wherein bottle 100 is inverted, shaking step 232, wherein vessel 110 is moved in any combination of translatory and rotational movements, or both inverting step 228 and shaking step 232.

In withdrawal step 236, lid 118 is operated to withdraw shaft 126 from grate 114 to a position wherein cavity 156 defined between grate 114 and shaft 126 is a desired size to allow liquid 146 or mixture 154 to move within cavity 156. Withdrawal step 236 can comprise operating lid 118 to a position wherein lid 118 seals opening 138, thereby preventing liquid 148, mixture 154, particles 158, or other items from exiting bottle 100 during agitating step 224.

Mixing step 216 is followed by removal step 220, wherein lid 118 is disengaged from vessel 110 and removed from opening 138. Following removal step 220, mixture 154 can be withdrawn from vessel 110. For example, mixture 154 can be poured out of opening 138.

In further examples, filling step 204 can be conducted at any time within process 200 before the end of mixing stage 216 except during performance of crushing step 212. For example, process 200 according to other implementations may begin with placing step 208 followed by crushing step 212. In some such further examples, filling step 204 can be performed after placing step 208, and in still further examples filling step 204 can be performed after crushing step 212. In some such examples, mixing step 216 comprises the mixing of the substance of the crushed items or tablets 122, or particles 158 produced during crushing step 212, that results from the contact between liquid 146 and those items, tablets 122, or particles 158 as liquid 146 is poured into vessel 110. Mixing step 216 according to some examples can therefore comprise filling step 204.

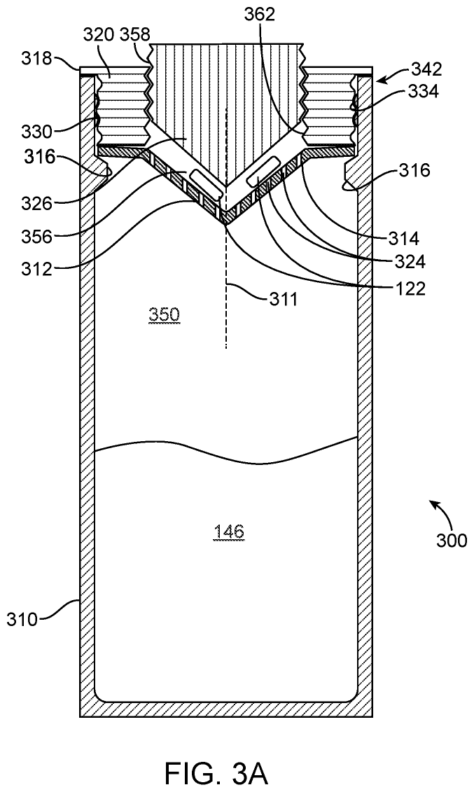

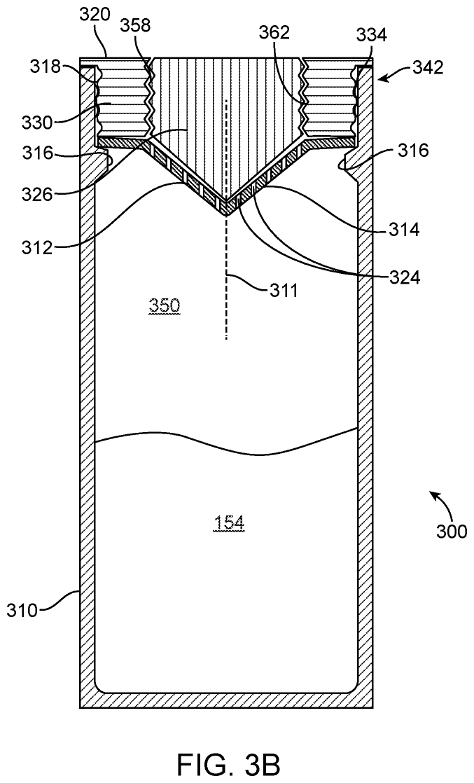

FIGS. 3A and 3B illustrate a bottle 300 according to another aspect of the present disclosure. Bottle 300 can also be used to crush tablets 122 or other items and facilitate mixing the product of that crushing with liquid 146 to create mixture 154.

Bottle 300 comprises a vessel 310, which can be similar to vessel 110 described above. Vessel 310 thus comprises an interior space 350, an open end 342 in which an opening is defined, and a vessel threaded portion 334 adjacent the opening and encircling a thread axis 311. Bottle 300 further comprises a grate 314, which can be similar to grate 114 described above, except for certain differences illustrated or described herein. Grate 314 can extend across the opening defined in open end 342 of vessel 310. Vessel 310 according to some examples can optionally also comprise one or more protrusions 316 to support grate 314, which can be similar to protrusions 116 described above. Vessel threaded portion 334 can be positioned between grate 314 and open end 342.

Bottle 300 further comprises a lid 318, which can also be similar to lid 118 except for certain differences illustrated or described herein. Lid 318 comprises a body 320 and a shaft 326, wherein shaft 326 is movable relative to body 320. Thus, when lid 318 is engaged to vessel 310 to close the opening defined in vessel's 310 open end 342, shaft 326 can be advanced toward grate 314 or withdrawn from grate 314 while body 320 remains stationary relative to vessel 310.

Shaft 326 can also be connected to body 320 in a manner that creates a fluid seal between body 320 and shaft 326 to enable lid 318 to seal the opening defined in the open end 342 of vessel 310. Body 320 and shaft 326 can be connected in any manner that allows user-controllable movement therebetween. In the illustrated example, body 320 and shaft 326 are threadedly connected. Thus, in addition to an outer threaded portion 330 whereby body 320 engages lid 318 to vessel threaded portion 334, body of the illustrated example comprises inner threaded portion 362. Inner threaded portion 362 can optionally be positioned within body 320 to be centered on thread axis 311 when lid 318 is threadedly engaged with vessel threaded portion 334 as shown in the illustrated example. Shaft 326 of the illustrated example comprises a shaft threaded portion 358 complementary to body threaded portion 362. Thus, shaft 326 can be advanced toward grate 314 or withdrawn from grate 314 by turning shaft 258 relative to body 320 while lid 318 is engaged with vessel 310. By moving shaft 326 toward grate 314, tablets 122 or other items trapped in a cavity 356 defined between grate 314 and shaft 326 can be crushed into particles that can be mixed with liquid 146 to create a liquid 154 as shown in the transition from FIG. 3A to FIG. 3B. Such mixing can be expedited by agitation and partial withdrawal of shaft 326 in a manner similar to that described above with regard to bottle 100 and process 200.

Bottle 300 of the illustrated example thus comprises a vessel 310 comprising an opening and a grate 314 positioned at the opening. Grate 314 comprises openings 324. Bottle 300 further comprises a lid 318 configured to seal the opening, and lid 318 comprises a shaft 326. Bottle 300 further comprises a first threaded portion 358 and a second threaded portion 362, wherein first threaded portion 358 and second threaded portion 362 are configured such that threadedly advancing first threaded portion 358 into second threaded portion 362 moves shaft 326 toward grate 314. In the illustrated example, lid 318 comprises both first threaded portion 358 and second threaded portion 362.

An end of shaft 326 directed toward grate 314 has a convex cone shape. A portion 312 of grate 314 has a complementary cone shape that is concave toward shat 326. The end of shaft 326 can therefore nest in portion 312 of grate 314, which can facilitate effective crushing of tablets 122 and other items. However, the end of shaft 326 and portion 312 of grate 314 can be of other shapes in other examples. The remainder of grate 314 outside of the cone shaped portion 312 is configured to seat against body 320 in a manner that prevents tablets 122 or other items from escaping from cavity 356 defined between shaft 326 and grate 314.

Bottle 300 of the illustrated example further comprises a ring in the form of body 320 that encircles shaft 326. Vessel 310 comprises a third threaded portion 334 and lid 318 comprises a fourth threaded portion 330. Lid 318 is configured to seal the opening defined in open end 342 of vessel 310 when fourth threaded portion 330 is threadedly engaged with third threaded portion 334.

Further according to the illustrated example, bottle 300 comprises a vessel 310. Vessel 310 comprises an opening defined in an open end 342 of vessel 310. Bottle 300 further comprises a grate 314 and a lid 318 configured to cover grate 314. Lid 318 comprises a shaft 326. A position of shaft 326 relative to grate 314 is adjustable while lid 318 is connected to vessel 310 and covers the opening defined in open end 342 of vessel 310. Shaft 326 is movable to nest with grate 314 while lid 318 is connected to vessel 310 and covers the opening defined in open end 342 of vessel 310. In some examples, the nesting position of shaft 326 with grate 314 can be a position wherein shaft 326 contacts grate 314, or at least nearly contacts grate 314. A crushing area 312 of grate 314 has a first cone shape, an end of shaft 326 has a second cone shape. Shaft 326 is movable to a position wherein the end of shaft 326 nests within crushing area 312 while lid 318 is connected to vessel 310 and covers the opening defined in open end 342 of vessel 310.

Lid 318 can be connected to vessel 310 after tablets 122 are placed on grate 314 to trap tablets 122 in a cavity 356 defined between grate 314 and shaft 326. Connecting lid 318 to vessel 310 also connects shaft 326 to vessel 310 through body 320. Thus, shaft 326 may be connected to vessel 310 after tablets 122 have been placed on grate 314. In further examples, shaft 326 can be removed from lid 318. In some such further examples, tablets 122 can be placed on grate 314 through body 320 while body 320 is engaged with vessel 310 and shaft 326 is disengaged from body 320 by dropping tablets 122 through the space within body 320 occupied by shaft 326 when shaft 326 is engaged to body 320. Shaft 326 can then be engaged to body 320 after tablets 122 have been dropped through body 320 onto grate 314 to trap tablets 122 in cavity 356 defined between grate 314 and shaft 326. Thus, in this second manner shaft 326 may be connected to vessel 310 after tablets 122 have been placed on grate 314.

It is to be appreciated that the Detailed Description section, and not the Summary and Abstract sections, is intended to be used to interpret the claims. The Summary and Abstract sections may set forth one or more but not all exemplary embodiments of the present disclosure but are not intended to limit the present disclosure and claims in any way.

The foregoing description of the specific embodiments so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the claims and their equivalents.

What is claimed is:

1. A bottle comprising:
a vessel comprising an opening;
a grate positioned at the opening;
a lid configured to seal the opening, wherein the lid comprises a shaft and a first threaded portion; and
a second threaded portion, wherein the first threaded portion and second threaded portion are configured such that threadedly advancing the first threaded portion into the second threaded portion moves the shaft toward the grate.

2. The bottle of claim 1, wherein the vessel comprises the second threaded portion.

3. The bottle of claim 2, wherein the lid seals the opening when the first threaded portion is advanced into the second threaded portion such that the lid reaches a first position relative to the vessel.

4. The bottle of claim 3, wherein the first threaded portion can be advanced into the second threaded portion to move the lid past the first position to a second position, wherein the shaft nests against the grate when the lid is in the second position.

5. The bottle of claim 1, wherein the grate extends across the opening.

6. The bottle of claim 5, wherein the vessel comprises the second threaded portion and an open end, wherein the opening is defined in the open end, and the second threaded portion is located between the grate and the open end.

7. The bottle of claim 6, wherein the vessel comprises a shoulder on an opposite side of the grate from the opening.

8. The bottle of claim 1, wherein a portion of the grate has a first cone shape and an end of the shaft has a second cone shape, the second cone shape being complementary to the first cone shape.

9. The bottle of claim 1, wherein the lid comprises the second threaded portion, and the shaft comprises the first threaded portion.

10. The bottle of claim 9, wherein the lid further comprises a ring that encircles the shaft and comprises the second threaded portion.

11. The bottle of claim 9, wherein the vessel comprises a third threaded portion and the lid comprises a fourth threaded portion, wherein the lid is configured to seal the opening when the fourth threaded portion is threadedly engaged with the third threaded portion.

12. A bottle comprising:
a vessel comprising an opening and an interior space, wherein the opening is a passage through which substances from outside of the vessel can reach the interior space;
a grate; and
a lid configured to cover the grate, wherein the lid comprises a shaft, and a distance of the shaft from the grate is adjustable while the lid is connected to the vessel and covers the opening, wherein the grate is positioned so that substances on an opposite side of the grate from the shaft can reach the interior space.

13. The bottle of claim 12, wherein the shaft is movable to nest against the grate while the lid is connected to the vessel and covers the opening.

14. The bottle of claim 13, wherein a crushing area of the grate has a first cone shape, an end of the shaft has a second cone shape, and the shaft is movable to a position wherein the end of the shaft nests against the crushing area while the lid is connected to the vessel and covers the opening.

15. A method of using the bottle of claim 12, comprising:
placing liquid in the vessel;
placing an item between the shaft and the grate; and
crushing the item by advancing the shaft toward the grate while the item is between the shaft and the grate.

16. The method of claim 15, wherein placing the item between the shaft and the grate comprises placing the item on the grate then connecting the shaft to the vessel.

17. The method of claim 15, comprising, after crushing the item:
withdrawing the shaft from the grate to a position wherein a cavity exists between the grate and the shaft while the lid seals the opening; and
agitating the liquid into the cavity by moving the bottle.

18. The method of claim 17, comprising:
after withdrawing the shaft, orienting the bottle so that the opening points downward; and
agitating liquid out of the cavity by moving the bottle.

19. The method of claim 15, wherein advancing the shaft toward the grate comprises threadedly advancing a first threaded portion of the bottle along a second threaded portion of the bottle.

20. The method of claim 15, wherein the item is a consumable tablet.
